(19) United States
(12) Patent Application Publication
(10) Pub. No.: US 2009/0193027 A1
(43) Pub. Date: Jul. 30, 2009

(54) INFORMATION SERVICE SYSTEM USING USN NODES AND NETWORK, AND SERVICE SERVER CONNECTABLE TO USN NODES THROUGH NETWORK

(75) Inventors: Mee-Bae Ahn, Seoul (KR); Kuk-Kyoung Kim, Yangsan Si (KR); Eun-Ju Lee, Gwangju Si (KR)

Correspondence Address: Jefferson IP Law, LLP, 1730 M Street, NW, Suite 807, Washington, DC, 20036, US

(73) Assignees: Mee-Bae Ahn, Seoul (KR); Kuk-Kyoung Kim, Yangsan Si (KR)

(21) Appl. No.: 12/177,581

(22) Filed: Jul. 22, 2008

(30) Foreign Application Priority Data
Jan. 28, 2008 (KR) 10-2008-0008555

(51) Int. Cl. G06F 17/30

(52) U.S. Cl. 707/9; 707/10; 707/E17.005

(57) ABSTRACT

An information service system using USN nodes, a network and a service server connectable to ubiquitous sensor network (USN) nodes through the network are disclosed. The information sensed by the USN nodes is transmitted to the service server connected to an external network, so that an administrator can check the context of surrounding environment where the USN nodes are installed, through the service server. The operation command for a specific object associated with a specific USN node, input by an administrator accessed the service server, is transmitted to the USN node via the network, so that the USN node can operate the specific object. The USN can be established at relatively small size, reducing installation costs, maintenance fees, and resource waste. Thus, the USN can be widely used in the applications.

### PRIORITY

This application claims the benefit under 35 U.S.C. § 119(a) of a Korean patent application filed on Jan. 28, 2008 in the Korean Intellectual Property Office and assigned Serial No. 2008-0008555, and the entire disclosures of both of which are hereby incorporated by reference.

### BACKGROUND OF THE INVENTION

1. Field of the Invention

The present invention relates to communication systems. More particularly, the present invention relates to an information service system using ubiquitous sensor network (USN) nodes and a network and to a service server connectable to USN nodes through the network.

2. Description of the Related Art

In recent years, ubiquitous sensor network (USN) nodes and their applications have been researched and developed to sense physical environment information and allow an administrator to check the sensed information or to perform the administrator's desired commands.

USN nodes are located within a predetermined area, establishing a ubiquitous sensor network (USN), and they communicate with each other to relay information therebetween through radio frequency (RF) transmission so that the information can be transmitted to a corresponding USN node as a destination. The technology related to the USN nodes has been disclosed in Korean Patent No. 10-0736392 entitled “UBIQUITOUS RF SYSTEM, NODE MODULE, AND OPERATION METHODS THEREOF.”

Since USN nodes wirelessly communicate with each other to relay information therebetween, they can be easily installed and thus widely used. Also, a variety of applications using USN nodes are proposed. The USN node applications have been disclosed through Korean Patent No. 10-0644280 entitled “CONTEXT DISPLAYING SYSTEM USING SENSOR NETWORK,” Korean Patent No. 10-0688090 entitled “USN-BASED SYSTEM AND METHOD FOR PROVIDING DANGEROUS ROAD INFORMATION IN REAL TIME,” Korean Patent No. 10-0788833 entitled “USN-BASED SYSTEM AND METHOD FOR MANAGING RIVER AND RIVER FACILITIES,” Korean Patent Publication No. 10-2007-0057597 entitled “LOCATION-BASED SERVICE PROVIDING SYSTEM AND METHOD USING GEOLOGICAL CODES IN USN-ENVIRONMENT,” and Korean Patent No. 10-0697690 entitled “UBIQUITOUS SENSOR NETWORK MODULE, AND RF RECOGNITION PARKING MANAGEMENT SYSTEM USING RFID MODULE IN REAL TIME.”

However, these applications using USN nodes must be connected to servers, respectively, to achieve their objectives. Due to the burden of installation costs and maintenance fees, if these applications are installed to be used in a relatively small network such as a home network, which is manageable by an individual, we do not make the best use of the features of the USN and the USN nodes. Therefore, the USN, USN nodes, and their applications cannot be widely used.

### SUMMARY OF THE INVENTION

An aspect of the present invention is to address at least the above-mentioned problems and/or disadvantages and to provide at least the advantages described below. Accordingly, an aspect of the present invention is to provide technology where ubiquitous sensor networks (USN's), each of which comprises a plurality of ubiquitous (USN) nodes, are connected to one service server through a network, so that the service server can manage the USN's.

In accordance with an exemplary embodiment of the present invention, an information service system is provided. The information service system includes ubiquitous sensor network (USN) nodes, a plurality of gateways, a service server, and a plurality of administrator.

Each USN node senses context information related to an environment in a predetermined area to generate sensed information, adds its unique code to the sensed information to generate information (sensed information+unique code), transmits the information (sensed information+unique code) through RF transmission, and relays the information (sensed information+unique code) between adjacent USN nodes through RF transmission. The gateway adds its identification code to the information (sensed information+unique code) received from the USN node to generate information (sensed information+unique code+identification code) and transmits the information (sensed information+unique code+identification code) to an external network. The service server, connected to the external network, receives the information (sensed information+unique code+identification code) from the gateway, identifies the gateway based on the identification code, identifies the USN node generating the sensed information based on the unique code, and updates sensed information previously recorded in a data table allocated to the gateway. The administrator terminal allows an administrator to access the service server, to undergo an authentication process, and to check the sensed information recorded in the data table allocated to the gateway.

Here, the service server is connected via a network to a plurality of gateways including the gateway and a plurality of administrator terminals including the administrator terminal.

In accordance with another exemplary embodiment of the present invention, an information service system is provided. The information service system includes ubiquitous sensor network (USN) nodes, a plurality of gateways, a service server, and a plurality of administrator terminals.

Each USN node receives an operation command whose destination is the USN node itself, operates an object associated with the USN node itself, and relays information between adjacent USN nodes through radio frequency (RF) transmission. The gateway transmits the operation command from an external network to the USN nodes. The service server, connected to the external network, authenticates an accessed administrator who is matched with the gateway to identify the gateway, and transmits the operation command for a specific object, requested by the administrator, to a specific USN node in charge of the specific object, as a destination, through the gateway. The administrator terminal allows the administrator to access the service server, to undergo an authentication process, and to input the operation command for the specific object.

Here, the service server is connected via a network to a plurality of gateways including the gateway and a plurality of administrator terminals including the administrator terminal.

In accordance with another exemplary embodiment of the present invention, a service server connectable to ubiquitous sensor network (USN) nodes through a network is provided. The service server includes a communication unit, an information table, an information recognizing unit, an information updating unit, an authenticating unit, and an information transmitting unit.

The communication unit is connected via the network to a plurality of administrator terminals and a plurality of gateways, in which one gateway connects the USN nodes installed in a predetermined area to an external network via the network, and the USN nodes relay information therebetween through radio frequency (RF) transmission. The information table has data tables allocated to the plurality of gateways, respectively, which are connected through the communication unit. The information recognizing unit identifies a specific gateway and a specific USN node, based on an identification code and a unique code included in specific information, respectively, wherein the specific information is received from the specific gateway through the communication unit, and the specific information comprises the identification code for identifying the specific gateway, the unique code for identifying the specific USN code, and information sensed by the specific USN node. The information updating unit updates existing information in a recording blank, which corresponds to the specific USN node, in a data table allocated to the specific gateway identified by the information recognizing unit, with the sensed information currently transmitted from the specific USN node. The authenticating unit authenticates an administrator accessed through the administrator terminal, wherein the administrator is matched with the specific gateway of the plurality of gateways. The information transmitting unit outputs and transmits the sensed information in the data table allocated to the specific gateway to the administrator terminal, so that the administrator authenticated by the authenticating unit can read one or more pieces of sensed information received through the specific gateway.

In accordance with another exemplary embodiment of the present invention, a service server connectable to ubiquitous sensor network (USN) nodes through a network is provided. The service server includes a communication unit, an authenticating unit, a code adding unit, and a command transmitting unit.

The communication unit is connected via the network to a plurality of administrator terminals and a plurality of gateways, in which one gateway connects an external network via the network to the USN nodes installed in a predetermined area, and the USN nodes relay information therebetween through radio frequency (RF) transmission. The authenticating unit authenticates an administrator who accesses an administrator terminal through the communication unit, wherein the administrator is matched with a specific gateway of the plurality of gateways. The code adding unit adds a transmission code to an operation command for operating a specific object associated with a specific USN node through the specific gateway, wherein the operation command is input by the authenticated administrator through the administrator terminal and the transmission code serves as a destination for the specific USN node that operates the specific object. The command transmitting unit transmits the operation command including the transmission code to the specific gateway.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiment of the present invention will be more apparent from the following detailed description in conjunction with the accompanying drawings, in which:

FIG. 1 is a view illustrating a service system according to an exemplary embodiment of the present invention;

FIG. 2 is a schematic block diagram illustrating a service server installed in the service system of FIG. 1;

FIG. 3 is an exemplary view illustrating a data table in the service serve of FIG. 2;

FIG. 4 is a view illustrating a service system according to an exemplary embodiment of the present invention;

FIG. 5 is a schematic block diagram illustrating a service server installed in the service system of FIG. 4;

FIG. 6 is an exemplary view illustrating a command chart in the service server of FIG. 5.

Throughout the drawings, like reference numerals will be understood to refer to like parts, components and structures.

### BRIEF DESCRIPTION OF SYMBOLS IN THE DRAWINGS

N1˜N7, S1˜S7: USN nodes
S1, S2: service server
P1˜P3: administrator terminal
21: communication unit
22: information table
23: information recognizing unit
24: information updating unit
25: authenticating unit
26: information transmitting unit
51: communication unit
52: authenticating unit
53: code adding unit
54: command transmitting unit

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and structures may be omitted for clarity and conciseness.

### Embodiment 1

A service system according to an exemplary embodiment of the present invention is related to technology that enables an administrator to check information sensed by USN nodes.

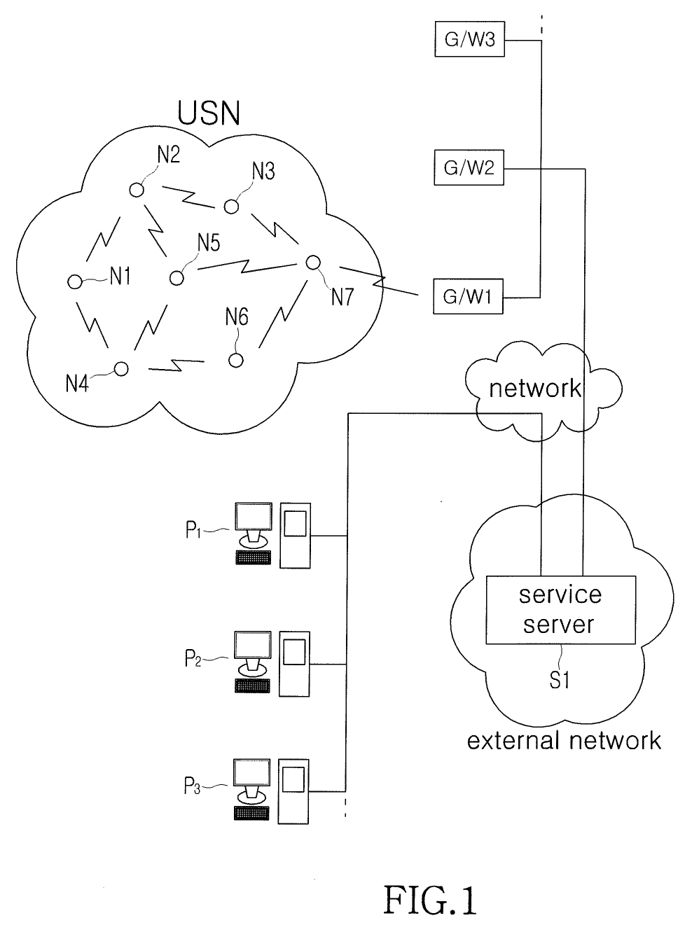

FIG. 1 is a view illustrating a service system according to an exemplary embodiment of the present invention.

As shown in FIG. 1, the service system includes a plurality of USN nodes N1 to N7, gateways G/W1 to G/W3, a service server S1, and administrator terminals P1 to P3.

The plurality of USN nodes N1 to N7 are located in a predetermined area, such as houses, offices, sites, buildings, etc. to establish one USN (i.e., the same USN). The respective USN nodes N1 to N7 exert their sensing functions to sense the surrounding environments (human body, door or window open/close state, image shooting, power consumption, temperature, humidity, light, electronic appliance ON/OFF operation, and heating boiler operation state, etc.). The respective USN nodes N1 to N7 add their identification codes to the sensed information and then transmit them to each other through radio frequency (RF) transmission. The sensed information is transmitted and relayed to each other in RF transmission until the sensed information, sensed by a specific USN node of the plurality of USN nodes N1 to N7, is transmitted to the gateway G/W1 as a destination. The identification code represents a code that serves to differentiate between the USN nodes N1 to N7 wirelessly connected to each other through the same USN.

FIG. 1 does not show other USN's associated with the respective gateways G/W2 and G/W3, however, the respective gateways G/W2 and G/W3 also perform the same function as the gateway G/W1. Therefore, except for specific cases, the exemplary embodiment of the present invention will be described based on the gateway G/W1 and the USN nodes N1 to N7 associated with the gateway G/W1.

A part of the plurality of USN nodes may have the same sensing function within the same USN, sensing temperature in a bed room, a living room, a balcony, and a bath room.

The gateway G/W1 adds its identification code to information received from the USN nodes N1 to N7, which include sensed information including a unique code, and then transmits the information to the external network. Through the identification code, the service server S1 can identify the plurality of gateways G/W1 to G/W3. The identification code may be implemented by an MAC or a predetermined code. The external network is differentiated from the USN's, with respect to the gateway G/W1 and the network. The gateway G/W1 connects the USN nodes N1 to N7 establishing one USN in a predetermined area to the external network via the network, so that the gateway G/W1 can collect pieces of information from the USN nodes N1 to N7 and transmit them to the service server S1. The gateway G/W1 may be implemented by a USN node (i.e., an end node) that can communicate with the external network.

As shown in FIG. 1, the service server S1 may be installed to the external network. The service server S1 is connected via the network to a plurality of gateways G/W1 to G/W3 and the plurality of administrator terminals P1 to P3. The network includes a public network, such as a mobile communication network or wired/wireless Internet, and a dedicated network. The plurality of administrator terminals P1 to P3 perform the same function. The service server S1 receives information (which includes, sensed information, a unique code, and an identification code) transmitted from the gateway G/W1. The service server S1 identifies the gateway G/W1 based on the identification code. Also, the service server S1 identifies the USN node, which generated the sensed information, based on the unique code. After performing the identification process based on the identification information, the service server S1 update sensed information in the data table allocated to the gateway G/W1.

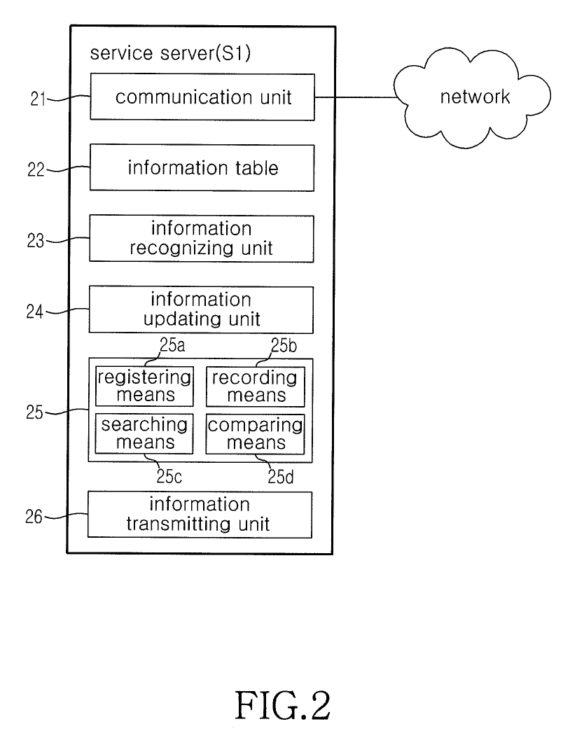

FIG. 2 is a schematic block diagram illustrating a service server installed in the service system of FIG. 1.

Referring to FIG. 2, the service server S1 includes a communication unit 21, an information table 22, an information-recognizing unit 23, an information-updating unit 24, an authenticating unit 25, and an information-transmitting unit 26.

The communication unit 21 is connected via the network to the plurality of administrator terminals P1 to P3 and the plurality of gateways G/W1 to G/W3.

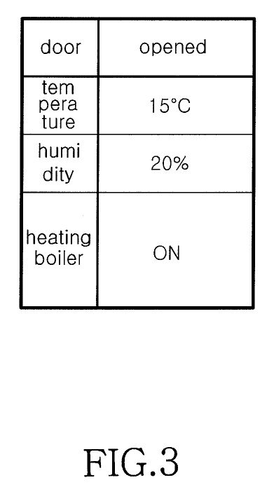

The information table 22 includes data tables allocated to the respective gateways G/W1 to G/W3 connected through the communication unit 21. When one of the data tables is allocated to the gateway G/W1, it can be updated, in real time, with the sensed information transmitted from the gateway G/W1. For example, as shown in FIG. 3

FIG. 3 is an exemplary view illustrating a data table in the service serve of FIG. 2.

Referring to FIG. 3, the sensed information collected in the gateway G/W1 includes a door open/close state, temperature, humidity, and heating boiler operation state. Also, the USN, connected via the gateway G/W1 to the service server S1, includes USN nodes for sensing a door open/close state, temperature, humidity, and a heating boiler operating state.

When the information recognizing unit 23 receives specific information from the gateway G/W1, in which the specific information includes an identification code for identifying a gateway, a unique code for identifying a specific USN node, and sensed information sensed by the specific USN node, it identifies the gateway G/W1 and the specific USN node of the USN nodes N1 to N7, which has generated the sensed information, based on the identification code and the unique code, which are included in the specific information.

The information-updating unit 24 updates existing information, which is in a recording blank corresponding to the specific USN node (N1, N2, . . . , or N7) in the data table allocated to the gateway G/W1 identified by the information-recognizing unit 23, with the sensed information currently transmitted from the specific USN node (N1, N2, . . . , or N7).

The authentication unit 25 operates the administrator terminal P1 and authenticates an accessed administrator. To this end, the authentication unit 25 includes a registering means 25a for registering information necessary for authentication, a recording means 25b having a registration table where registered authentication information is recorded, a searching means 25c for searching for authentication information in a registration table, and a comparing means 25d for comparing authentication information searched by the searching means 25c with authentication information that is input by an administrator though an administrator terminal P1 and for checking whether the two pieces of authentication information coincide with each other. The authentication information includes an identification number (ID) for identifying an administrator, a password, various data related to the administrator, and a differentiation code of a gateway G/W1 that is matched with the administrator. The differentiation code matches with an identification code, or the differentiation code may be an identification code. When the accessed administrator is authenticated, the service server S1 can identify the gateway G/W1 matched with a corresponding administrator.

The information-transmitting unit 26 outputs and transmits the sensed information in the data table allocated to the specific gateway G/W1 to the administrator terminal P1, so that the administrator authenticated by the authentication unit 25 can read the sensed information received through the specific gateway G/W1 matched with a corresponding administrator.

The administrator terminal P1 represents a communication terminal manipulated by an administrator, so that the administrator accesses the service server S1, undergoes an authentication process, and checks the sensed information recorded in the data table that is allocated to the gateway G/W1 matched with the administrator. The administrator terminal P1 may be implemented by any devices provided that they can access the service server S1 via the network and then allow the administrator to check sensed information recorded in the data table. For example, the administrator terminal P1 includes a personal computer or a mobile communication terminal that can communicate with the service server and output received sensed information.

The following is a description how the service system transmits and checks the sensed information.

If a specific USN node is a USN node N4 that can sense temperature in a living room, the USN node N4 adds its unique code, which is used to identify itself from other USN nodes N1, N2, N3, N5, N6, and N7, to the sensed temperature information and then transmits the information (the sensed temperature information+the unique code of the USN node N4) through RF transmission.

The information (the sensed temperature information+the unique code of the USN node N4) is wirelessly relayed and transmitted through adjacent USN nodes N6 and N7 to the specific gateway G/W1 that connects the USN, established by the USN node N4, to an external network.

The specific gateway G/W1 adds its identification code, which is used to identify itself from other gateways G/W2 and G/W3, to the received information (the sensed temperature information+the unique code of the USN node N4) and then transmits the information (the sensed temperature information+the unique code of the USN node N4+ the identification code of the gateway G/W1) through the network to the service server S1 as a destination IP.

The service server S1 receives the information (the sensed temperature information+the unique code of the USN node N4+ the identification code of the gateway G/W1) and then updates temperature information in the data table allocated to the specific gateway G/W1. After that, the service server S1 transmits the sensed information in the data table to the administrator terminal P1 so that an administrator accessed the service server S1 can read the information.

The service server S1 further performs the following procedure.

The service server S1 performs a registration process using the registering means 25a and the recording means 25b of the authentication unit 25, so that the service server S1 can sort and update information transmitted from the plurality of gateways G/W1 to G/W3 or authenticate an accessed administrator. The information necessary for the registration process can be input with installation of a USN and a gateway G/W1. Similar to the information inputting method through the Internet or the mobile communication, the information necessary for the registration process can also be input by an administrator who administers a USN or an administrator who administers the service server S1. As described above, the information registered through the registration process includes authentication information, gateway distinguishing codes for distinguishing between gateways G/W1, G/W2, and G/W3, and node distinguishing codes for distinguishing between USN nodes N1 to N7 establishing a corresponding USN. The node distinguishing code matches with a unique code. The node distinguishing code may be implemented by a unique code. If a new USN node is installed on the USN, then the newly installed USN node must also be registered.

After completing the registration process through the registering means 25a and the recording means 25b, the communication unit receive the information (the sensed temperature information+the unique code of the USN node N4+ the identification code of the gateway G/W1) from the gateway G/W1.

The information recognizing unit 23 identifies the gateway G/W1 and the USN node N4 based on the identification code and the unique code included in the information received through the communication unit 21. The information updating unit 24 updates the existing information, which is in a recording blank corresponding to the USN node N4 in the data table allocated to the gateway G/W1, identified by the distinguishing code, with the temperature information included in the currently received information.

When an administrator accesses through the administrator terminal P1 later, the searching means 25c and the comparing means 25d of the authenticating unit 25 operate to authenticate the accessed administrator. Through this authentication process, the service server S1 can determine whether an accessed administrator is authenticated, and confirm that the gateway G/W1 is matched with the authenticated administrator.

Next, when an administrator needs to read the information sensed by the USN nodes N1 to N7 located in a predetermined area, the information transmitting unit 26 outputs and transmits the sensed information in a data table allocated to the specific gateway G/W1 to the administrator terminal P1. The transmission process may be implemented in such a way that all pieces of sensed information in the data table can be transmitted to the administrator terminal P1 or only specific sensed information required by the administrator can be transmitted to the administrator terminal P1. Also, the transmission process may also be implemented in such a manner that, if an administrator has been authenticated, pieces of sensed information can be transmitted to the administrator terminal P1 without additional procedures and without the inspection request of the administrator.

Similar to a method where Internet users' homepages are provided through an Internet website, the present invention may be implemented in such a way that administrator's homepages can be provided to the authenticated administrators. Therefore, if an administrator undergoes an authentication process and is permissible, then the authenticated administrator can open the sensed information through his/her homepage.

### Embodiment 2

The service system according to the present embodiment is related to technology that transmits operation commands, received from an administrator, to USN nodes, so that the USN nodes can operate objects. The objects include door opening/closing devices, window opening/closing devices, heating boilers, electronic appliances, and light devices, etc.

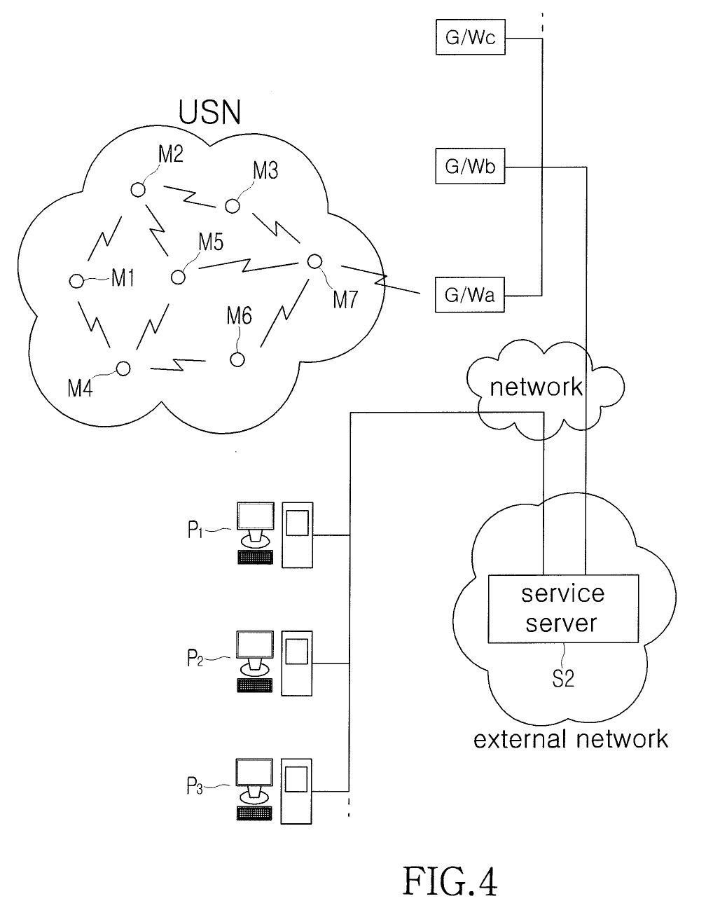

FIG. 4 is a view illustrating a service system according to another exemplary embodiment of the present invention.

As shown in FIG. 4, the service system includes a plurality of USN nodes M1 to M7, gateways G/Wa to G/Wc, a service server S2, and administrator terminals P1 to P3.

The plurality of USN nodes M1 to M7 can be installed in a predetermined area, such as houses, offices, sites, buildings, etc. to establish one USN (i.e., the same USN). The USN nodes M1 to M7 receive operation commands and then transmit them to the objects associated therewith, thereby controlling the objects. The USN nodes M1 to M7 relay the information therebetween through radio frequency (RF) transmission, so that an operation command can be transmitted through a gateway G/Wa from the service server S2 to a corresponding USN node of the USN nodes M1 to M7, which is a destination of the operation command. FIG. 4 does not show USN's associated with the gateways G/Wb and G/Wc, however, the gateways G/Wb and G/Wc also perform the same function as the gateway G/Wa. Therefore, except for specific cases, the embodiment of the present invention will be described based on the gateway G/Wa.

These USN nodes M1 to M7 are integrally formed with their objects forming modules, respectively. Also, the USN nodes M1 to M7 may be implemented in such a way that they can be separately installed from their corresponding objects. When the USN nodes M1 to M7 are formed as modules with their objects, it is preferable that the USN nodes M1 to M7 include controllers for controlling their corresponding objects. On the contrary, when the USN modules M1 to M7 are implemented in such a way that they installed separately from their corresponding objects, operation commands can be transmitted to the corresponding objects.

The gateway G/Wa receives operation commands whose destinations are the USN nodes M1 to M7 from the service server S2 connected to the external network, and then transmits them to the USN through RF transmission.

The service server S2 is connected to the external network. Also the service server S2 is connected via a network to the plurality of gateways G/Wa to G/Wc and the plurality of administrator terminals P1 to P3. The service server S2 receives an operation command for a specific object from the administrator terminal P1 and then transmits it to the gateway G/Wa connected to the USN including a corresponding USN node (M1, M2, . . . , M6, or M7) that operates the specific object, in which the corresponding USN node (M1, M2, . . . , M6, or M7) is the destination of the operation command.

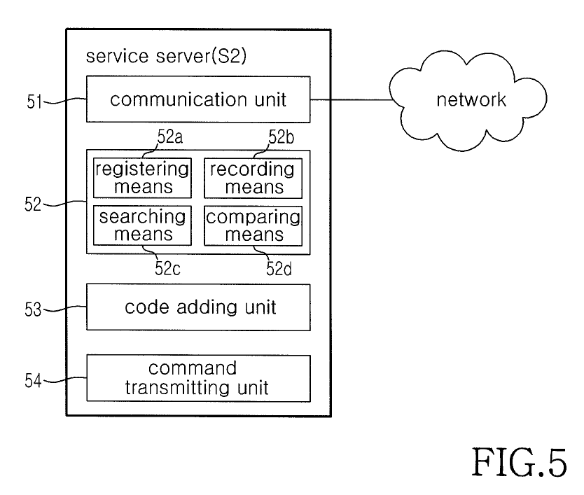

FIG. 5 is a schematic block diagram illustrating a service server installed in the service system of FIG. 4.

Referring to FIG. 5 of a schematic block diagram illustrating the service server S2 installed in the service system of FIG. 4, the service server S2 includes a communication unit 51, an authenticating unit 52, a code adding unit 53, and a command transmitting unit 54.

The communication unit 51 is connected via the network to the plurality of administrator terminals P1 to P3 and the plurality of gateways G/Wa to G/Wc.

The authenticating unit 52 operates the administrator terminal P1 and authenticates an accessed administrator. To this end, the authentication unit 52 includes a registering means 52a for registering information necessary for authentication, a recording means 52b having a registering table where registered authentication information is recorded, a searching means 52c for searching for authentication information in a registration table, and a comparing means 25d for comparing authentication information searched by the searching means 25c with authentication information that is input by an administrator through an administrator terminal P1 and for checking whether the two pieces of authentication information coincide with each other. The authentication information includes an identification number (ID) for identifying an administrator, a password, various data related to the administrator, an IP address of the gateway G/Wa matched with the administrator, and distinguishing codes of respective USN nodes M1 to M7 wirelessly connected to a corresponding gateway. The distinguishing code represents a code enabling a USN node to identify that a destination corresponds to the USN node itself. The service server S2 has the distinguishing code. When an accessed administrator is authenticated, the service server S2 can identify the gateway G/Wa matched with the administrator and thus identify a corresponding USN node (M1, M2, . . . , M6, or M7) in charge of an operating object that the administrator wants to operate.

The code adding unit 53 adds a transmission code to the operation command for a specific operating object, which is transmitted by an authenticated administrator through the administrator terminal P1. The transmission code includes an IP address of the gateway G/Wa and a distinguishing code of a USN node (M1, M2, . . . , M6, or M7) in charge of the specific operating object.

The command transmitting unit 54 transmits the operation command, which includes the transmission code, to the gateway G/Wa through the network.

The administrator terminal P1 represents a communication terminal that allows the administrator to access the service server S2, undergo an authentication process, and input operation commands.

The following is a description of how the service system transmits operation commands and operates objects.

When the service server S2 receives an operation command (for example, a door closing command) for a specific object (for example, a door opening/closing device) from the administrator terminal P1, it transmits the operation command to a corresponding USN node M1 in charge of the door opening/closing device (not shown). After the door closing command passes through the gateway G/Wa and is relayed by the other USN nodes M7, M3, and M2, it arrives at the USN node M1. The USN node M1 checks whether the destination of the received door closing command corresponds to the USN node M1 itself. If the destination of the received door closing command corresponds to the USN node M1, the USN node M1 controls the door opening/closing device to close the door, according to the door closing command. On the contrary, if the destination of the received door closing command does not correspond to the USN node M1, the USN node M1 retransmits the received door closing command to the adjacent USN node M4.

The service server S2 further performs the following procedure.

The service server S2 performs a registration process using the registering means 52a and the recording means 52b of the authentication unit 52, so that it can authenticate an accessed administrator and correctly transmit the operation command for a specific object from the administrator terminal P2 to a corresponding USN node (M1, M2, . . . , M6, or M7) in charge of the specific object. The information registered through the registration process includes authentication information, the IP address of the gateway G/Wa, and distinguishing codes for distinguishing between USN nodes M1 to M7 establishing the USN. The distinguishing code is a code enabling a USN node to check whether a destination corresponds to the USN node itself. And the service server S2 has the distinguishing code.

After completing the registration process through the registering means 52a and the recording means 52b, the searching means 52c and the comparing means 52d of the authentication unit 52 operate to authenticate an administrator accessed through the administrator terminal P1.

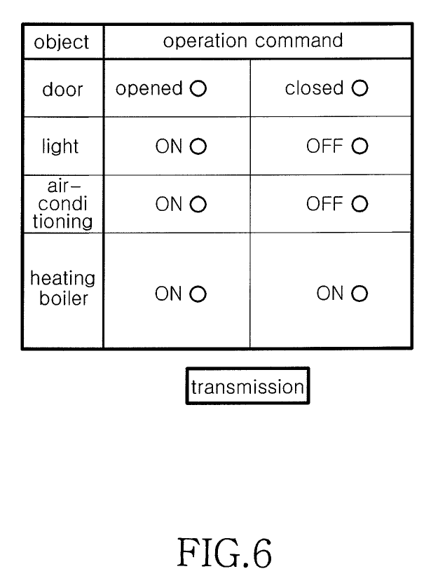

When the authenticated administrator inputs a door closing command for a door opening/closing device, the code adding unit 53 adds the IP address of the gateway G/W1 matched with the administrator and the distinguishing code of the USN node M1 in charge of the door opening/closing device to the door closing command. In order to allow the administrator to conveniently input the operation commands, the service server S2 may transmit a command chart to the administrator terminal P1, as shown in FIG. 6, or the service server S2 may allocate homepages to respective administrators, as described in embodiment 1.

The command transmitting unit 54 transmits the operation command including the transmission code by the code adding unit 53 to the network through the communication unit 51, so that the operation command can be transmitted via the gateway G/W1 to the USN node M1.

In the embodiments, one service system performs the steps of transmitting and checking the sensed information and another service system performs the steps of transmitting operation commands and operating objects, however, it should be understood that the service system can be modified in such a way to perform the steps of transmitting and checking the sensed information and the steps of transmitting operation commands and operating objects.

For example, when a USN node transmits its sensed information about a door open/close state to the service server through the gateway, an administrator accesses the service server, checks the sensed information and then inputs an operation command (for example, a door closing command) for operating an door opening/closing device to the service server. The service server transmits the door closing command to the USN node in charge of the door opening/closing device. Here, the service system can be implemented in such a way that one USN node sensing the door open/close state is separated from another USN node operating the door opening/closing device, however, it is preferable that these two USN nodes can be integrally formed with a single body.

As described above, since one service server integrally manages ubiquitous sensor networks (USN's) including a plurality of USN nodes, installation costs and maintenance fees can be reduced and resources are not wasted. Also, since a relatively small-sized USN can be established, USN nodes can be widely used in various applications.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims and their equivalents.

What is claimed is:

1. An information service system comprising:
ubiquitous sensor network (USN) nodes, each USN node for sensing context information related to an environment in a predetermined area to generate sensed information, adding its unique code to the sensed information to generate information (sensed information+unique code), transmitting the information (sensed information+unique code) through RF transmission, and relaying the information (sensed information+unique code) between adjacent USN nodes through RF transmission;
a gateway for adding its identification code to the information (sensed information+unique code) received from the USN node to generate information (sensed information+unique code+identification code) and transmitting the information (sensed information+unique code+identification code) to an external network;
a service server connected to the external network, for receiving the information (sensed information+unique code+identification code) from the gateway, identifying the gateway based on the identification code, identifying the USN node generating the sensed information based on the unique code, and updating sensed information previously recorded in a data table allocated to the gateway; and
an administrator terminal for allowing an administrator to access the service server, to undergo an authentication process, and to check the sensed information recorded in the data table allocated to the gateway,
wherein the service server is connected via a network to a plurality of gateways including the gateway and a plurality of administrator terminals including the administrator terminal.

2. An information service system comprising:
ubiquitous sensor network (USN) nodes, each USN node for receiving an operation command whose destination is the USN node itself, operating an object associated with the USN node itself, and relaying information between adjacent USN nodes through radio frequency (RF) transmission;
a gateway for transmitting the operation command from an external network to the USN nodes;
a service server connected to the external network, for authenticating an accessed administrator who is matched with the gateway to identify the gateway, and transmitting the operation command for a specific object, requested by the administrator, to a specific USN node in charge of the specific object, as a destination, through the gateway; and
an administrator terminal for allowing the administrator to access the service server, undergo an authentication process, and input the operation command for the specific object,
wherein the service server is connected via a network to a plurality of gateways including the gateway and a plurality of administrator terminals including the administrator terminal.

3. A service server connectable to ubiquitous sensor network (USN) nodes through a network, the service server comprising:
a communication unit connected via the network to a plurality of administrator terminals and a plurality of gateways, wherein one gateway connects the USN nodes installed in a predetermined area to an external network via the network, and the USN nodes relay information therebetween through radio frequency (RF) transmission;
an information table having data tables allocated to the plurality of gateways, respectively, which are connected through the communication unit;
an information recognizing unit for identifying a specific gateway and a specific USN node, based on an identification code and a unique code included in specific information, respectively, wherein the specific information is received from the specific gateway through the communication unit, and the specific information comprises the identification code for identifying the specific gateway, the unique code for identifying the specific USN code, and information sensed by the specific USN node;
an information updating unit for updating existing information in a recording blank, which corresponds to the specific USN node, in a data table allocated to the specific gateway identified by the information recognizing unit, with the sensed information currently transmitted from the specific USN node;
an authenticating unit for authenticating an administrator accessed through the administrator terminal, wherein the administrator is matched with the specific gateway of the plurality of gateways; and
an information transmitting unit for outputting and transmitting the sensed information in the data table allocated to the specific gateway to the administrator terminal, so that the administrator authenticated by the authenticating unit can read one or more pieces of sensed information received through the specific gateway.

4. A service server connectable to ubiquitous sensor network (USN) nodes through a network, the service server comprising:
a communication unit connected via the network to a plurality of administrator terminals and a plurality of gateways, wherein one gateway connects an external network via the network to the USN nodes installed in a predetermined area, and the USN nodes relay information therebetween through radio frequency (RF) transmission;
an authenticating unit for authenticating an administrator who accesses an administrator terminal through the communication unit, wherein the administrator is matched with a specific gateway of the plurality of gateways;
a code adding unit for adding a transmission code to an operation command for operating a specific object associated with a specific USN node through the specific gateway, wherein the operation command is input by the authenticated administrator through the administrator terminal and the transmission code serves as a destination for the specific USN node that operates the specific object; and
a command transmitting unit for transmitting the operation command including the transmission code to the specific gateway.
